(19) United States
(12) Patent Application Publication
(10) Pub. No.: US 2002/0014394 A1
(43) Pub. Date: Feb. 7, 2002

(54) Conveyor, in particular an accumulating roller conveyor

(76) Inventors: Walter Mann, Bremen (DE); Michael Schmidt, Schwanewede (DE)

Correspondence Address: TECHNOPROP COLTON, L.L.C., P O BOX 567685, ATLANTA, GA, 311567685

(21) Appl. No.: 09/834,491

(22) Filed: Apr. 13, 2001

(30) Foreign Application Priority Data
Apr. 26, 2000 (DE) 10021252.2

(51) Int. Cl. B65G 21/20

(52) U.S. Cl. 198/837

(57) ABSTRACT

Conveyors, in particular accumulating roller conveyors (10), feature a profile section (11), in which a top belt (15) and a bottom belt (16) of a accumulating roller chain (14) are guided. In known accumulating roller conveyors (10), the profile section (11) has permanently divided receiving spaces (26) for the top belt (15) and the bottom belt (16). The receiving space (26) for the bottom belt (16) is closed on all sides, which has an adverse effect on the accessibility of the receiving space (26) for the bottom belt (16), in particular during the mounting of same.

The invention provides for a profile section (11) which features a receiving space (26) for the top belt (15) and the bottom belt (16), with a detachable dividing plate (27) creating a lower sectional space (29) for the bottom belt (16) in the receiving space (26). In this manner, the return channel of the bottom belt (16) of the accumulating roller chain (14) formed by the lower sectional space (29) is accessible from a top open side of the profile section (11).

The invention relates to a conveyor, in particular to an accumulating roller conveyor, for work pieces, workpiece holders or other objects pursuant to the introductory clause of claims 1 and 16, respectively.

The conveyor referred to here is employed in the transport of workpieces or workpiece holders along assembly lines, for instance. But it may also involve a conveyor for transporting other (lumpy) items. Such a conveyor has been designed many times over as an accumulating roller conveyor. The conveyor is provided with a conveying path which preferably travels in a loop and which is largely made up of elongate (straight) profile sections. The conveying strand, in particular an accumulating roller chain, is supported on the profile sections. In addition, the continuously driven conveying strand is guided by the profile section.

In known conveyors of this type, a space in the profile section for accommodating the conveying strand is permanently divided into two sectional spaces. Each of these sectional spaces accommodates a belt of the conveying strand. Accordingly, a bottom belt of the conveying strand is therefore guided in the (lower) sectional space, which is closed on all sides. This means that during the assembly of the conveyor strand, its bottom belt must be inserted through the open end sides of the profile section and into the otherwise closed sectional space. This makes the assembly, maintenance and repair of the conveying strand—particularly of the accumulating roller chain—difficult and time-consuming.

Furthermore, the known conveyors are provided with various function elements, such as deflectors (curves) and shunts, which have to be connected to the various segments of the profile sections which form the conveying path. For this purpose, the profile sections have specially designed ends which are configured to fit the connecting points of the function elements. This requires an individual design and manufacture in particular of the ends of the profile sections and requires that the connecting points of the function elements are assembled with precisely the designated ends of the profile section. This adds to the difficulty in assembling the conveying path of the conveyor.

Proceeding from this point, the invention has as its objective the creation of a conveyor, in particular of a accumulating roller conveyor, which is easy to assemble, repair and maintain.

A conveyor which solves this objective is disclosed by the features of claim 1. By virtue of the profile section having a receiving space open at one side where the top belt and the bottom belt of the conveyor strand can be inserted, the bottom belt of the conveyor strand no longer has to be pushed into the profile section from at least one open end face. Instead, the bottom belt as well as the top belt can be inserted through the open side into the receiving space of the profile section because the latter, according to the invention, is freely accessible for the bottom belt along its entire longitudinal extension. This makes it possible to assemble and disassemble the conveyor strand in and out of the profile section without having to separate the endless conveying strand.

A further provision is that the receiving space can be divided into two sectional spaces by means of at least one dividing plate. To this end the dividing plate is arranged detachably at a corresponding position in the receiving space. By using a removable dividing plate, a covered sectional space for receiving the bottom belt is closed as is the case in the known conveyors, and the dividing plate can then serve as a direct or indirect supporting plate for the top belt. But since the dividing plate is detachable, it is also possible to open the covered sectional space for receiving the bottom belt. The bottom belt can thus be laid into the profile section or removed from it via the preferably upper open side of the receiving space. With the subsequent insertion of the dividing plate into the profile section, the sectional space provided with the bottom belt is closed and the top belt can then be inserted via the same open side of the receiving space into the profile section, namely into the open (upper) sectional space.

According to a preferred embodiment of the profile section with sectional spaces lying one above the other and a lockable lower sectional space for receiving the bottom belt of the conveying strand, a bottom wall of the upper sectional space is formed by the dividing plate which closes the lower sectional space, with the top side of the upper sectional space lying opposite the dividing plate assigned to the open side of the profile section. This allows for a particularly easy assembly of the conveying strand in that the bottom belt, the dividing plate and the top belt can be inserted into the receiving space of the profile section.

According to a preferred embodiment of the invention, opposing and upright side walls of the receiving space are provided with facing projections, which lie in the same, preferably horizontal plane and on which the dividing plate for separating the receiving space into the two sectional spaces lies. If necessary, the projections can be assigned to click-stop elements which allow for a locking yet detachable connection of the dividing plate to the profile section. This arrangement prevents the dividing plate from lifting off the projection supports of the profile section during conveyor operation. As an alternative, the dividing plate can be screwed to the projections.

Pursuant to a further development of the invention, a bottom wall of at least one sectional space is assigned to a sliding layer for the corresponding belt of the conveyor strand. Such a sliding layer is preferably provided for the bottom walls of both sectional spaces. In this case, one sliding layer is arranged on the bottom wall of the profile section which connects the two side walls, while the other sliding layer is located on the dividing plate. The sliding layers are preferably formed by a guide profile in the corresponding sectional space. This guide profile can cover the bottom the respective sectional space either completely or in part. Like the dividing plate, the or each guide profile can be inserted into the profile section as a separate part. The guide profiles are either laid loosely on the bottom of the profile section or dividing wall, or are locked in place by catch-lock connections or the like on the profile section or on the dividing plate.

The invention also provides that the guide profiles are uniformly configured and have a bottom wall and two edge strips. The edge strips are assigned to opposing side walls of the profile section's receiving space such that the conveyor strand running along in the profile section also corresponds laterally to a sliding layer.

Pursuant to a preferred embodiment of the invention, the edge strips can be pivoted with respect to the associated bottom wall, preferably by means of hinges for connecting the edge strips to the bottom wall. The purpose of having the edge strips able to pivot with respect to the bottom wall is that the guide profile can be held by catch-locking on the bottom of the respective sectional space of the receiving space.

Also provided for is a longitudinal, preferably continuous recess on one side of the guide profile's bottom wall. This recess is formed such that it can accommodate the downward projecting portions of the accumulating rollers in the chain body of the accumulating roller chain without these portions of the accumulating rollers coming into contact with the bottom wall of the respective guide profile. By having such a recess assigned to only one side of the bottom wall, it is possible to drive the accumulating rollers on the guide profile depending on the relative positioning of the guide profile in the profile section, namely either with the recess facing upwards or facing downwards (covered). Depending on whether the recess lies on the top or bottom side of the bottom wall, the edge strips, which usually project above the bottom wall, must point to one side or the other of the bottom wall. The hinges lines between the bottom wall and the edge strips make it possible to flip the edge strips by 180° so that they can project with respect to one side of the bottom wall as chosen. In this way, the guide profile can be universally employed and used either with power-driven accumulating rollers or in cases not involving power-driven accumulating rollers.

A further conveyor for solving the aforementioned objective has the features disclosed in Claim 16. Accordingly, the ends of the profile sections are designed such that they can be joined to connecting points of various function elements. In this manner, the ends of the same profile section can be connected to different function elements, preferably all function elements, without having to employ profile sections with specially designed ends or take additional measures for adapting the parts. Conveying paths of any configuration can be formed using standard design profile sections in that each end of a profile section can be connected to a function element corresponding to the needs at hand.

Furthermore, the invention provides for the uniform formation of parallel, upright side walls of the profile sections. In particular, each side wall has continuous grooves accessible from the exterior which can be used for accommodating various kinds of fastening means.

The preferably T-shaped grooves have a leg lying in the interior of the respective side wall which is connected by a transverse web to the outer side of the respective side wall or bottom wall of the profile section. The foot of the leg thus forms a continuous slit running in the longitudinal direction of the profile section on the outer side of the respective side wall or bottom wall. The leg of the respective T-shaped groove lying in the interior of the corresponding wall is used for a positive-locking mounting support of a fastening element for other parts of the conveyor on the profile section, for example, for parts of a supporting framework. These fastenings preferably involve only so-called sliding blocks. In order that differently configured grooved blocks required for different purposes can be anchored in the same T-shaped groove of the profile section, the parallel web side walls bordering the web of the T-shaped groove are provided with extensions directed toward the leg, preferably in the form of steps. In these steps it is possible to arrange non-rotatable anchoring means having a narrower head which would otherwise not fit in the larger web of the T-shaped groove in a non-rotatable manner. A profile section having such a configuration can be employed universally.

A preferred exemplary embodiment of a conveyor according to the invention will be described more closely in the following as based on the accompanying drawing, which shows:

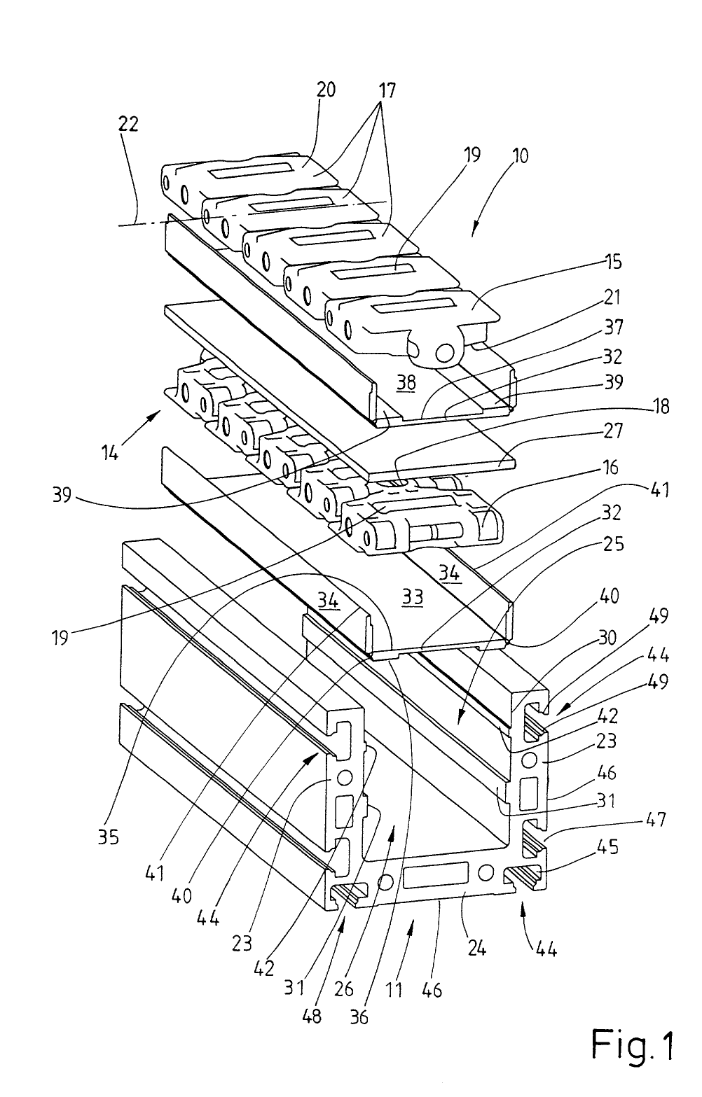

FIG. 1 a perspective view of a portion of a profile section with yet unmounted accumulating roller chain,

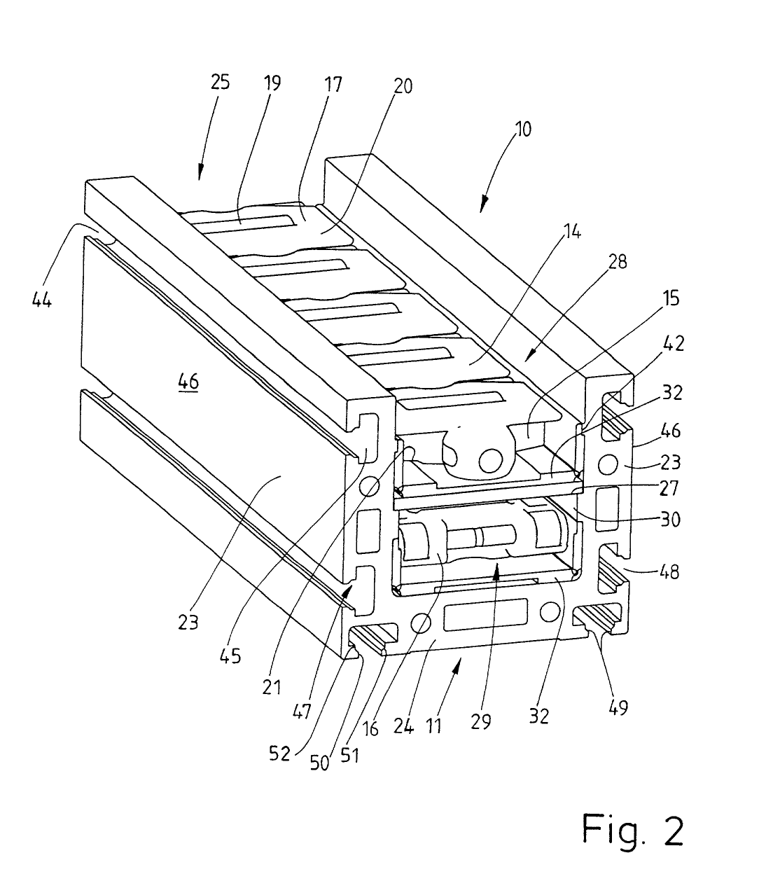

FIG. 2 view pursuant to FIG. 1 with mounted accumulating roller chain,

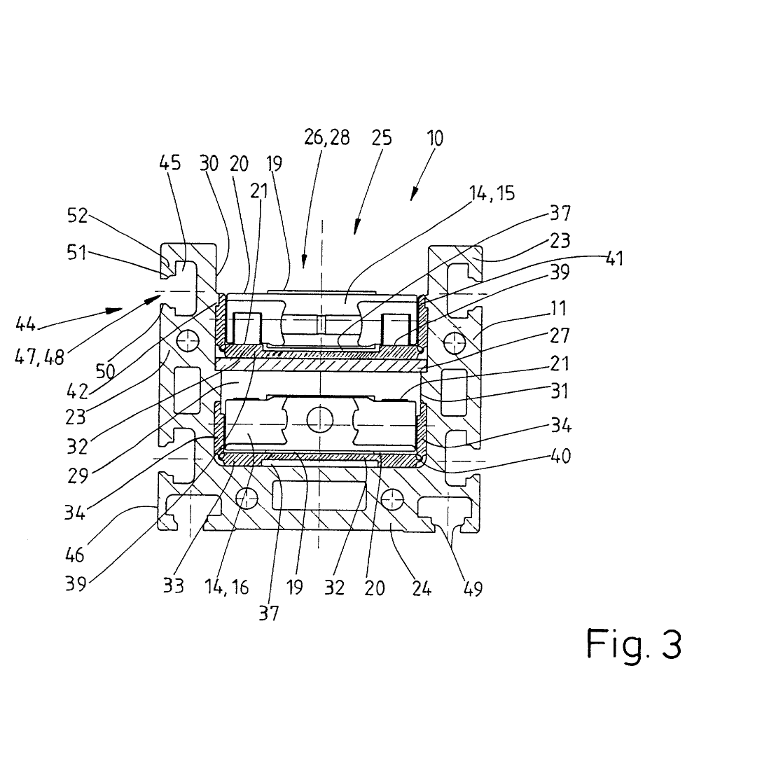

FIG. 3 cross-sectional view of the profile section with mounted accumulating roller chain pursuant to FIG. 2,

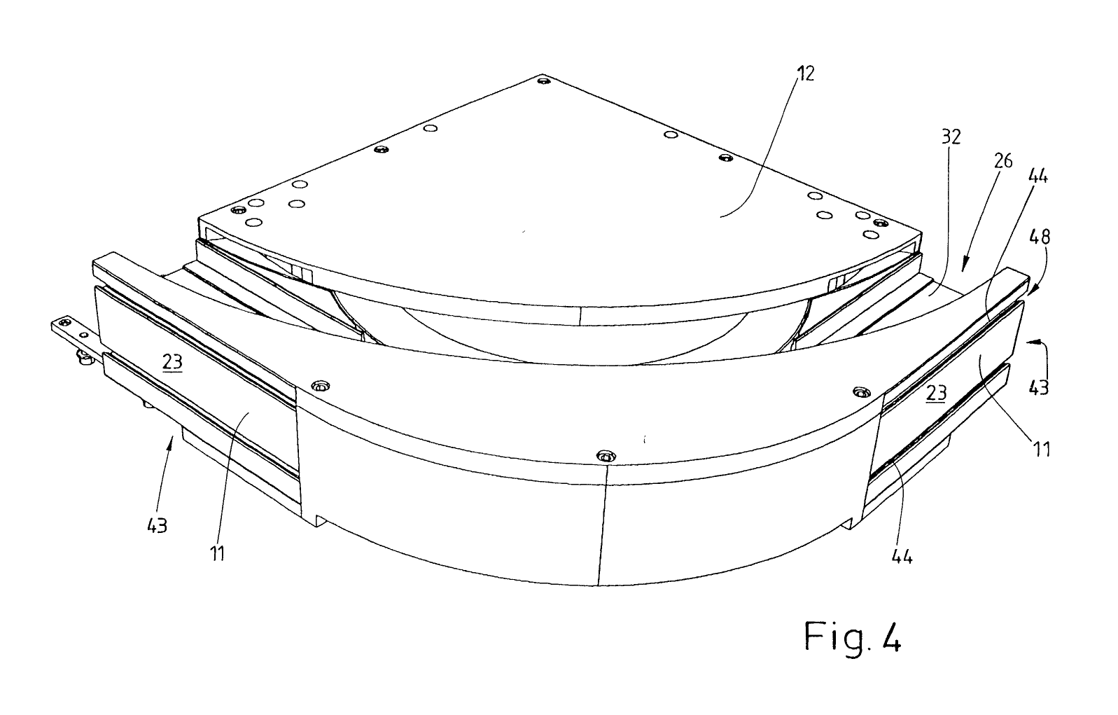

FIG. 4 perspective view of a mounted deflector between the ends of two profile sections,

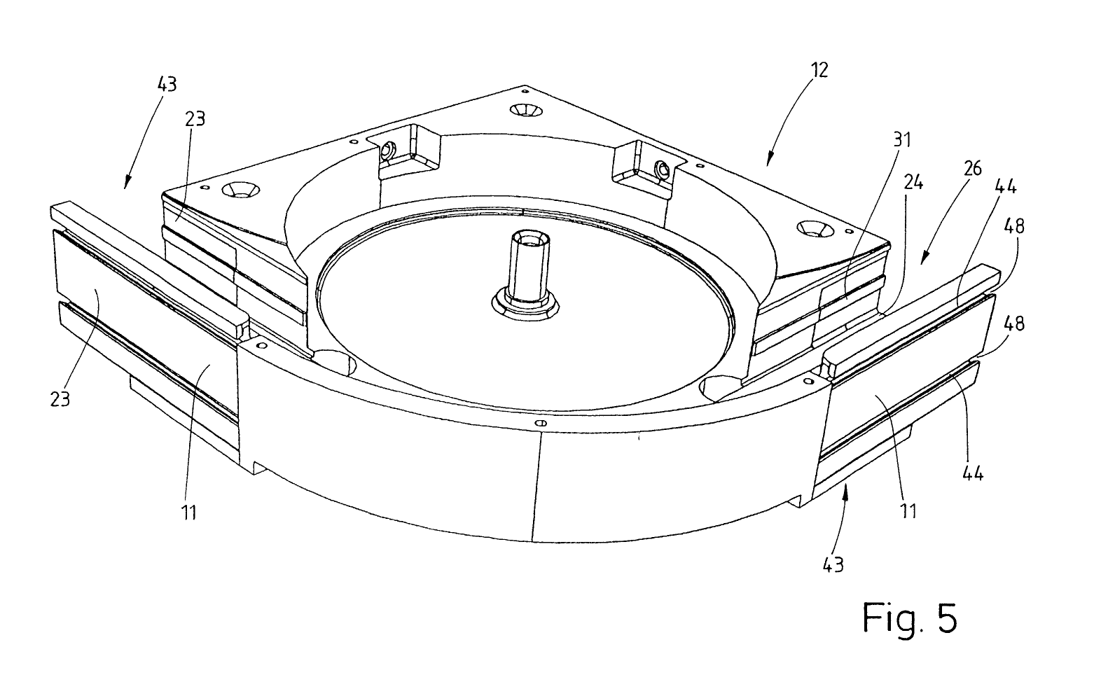

FIG. 5 the deflector of FIG. 4 without covers,

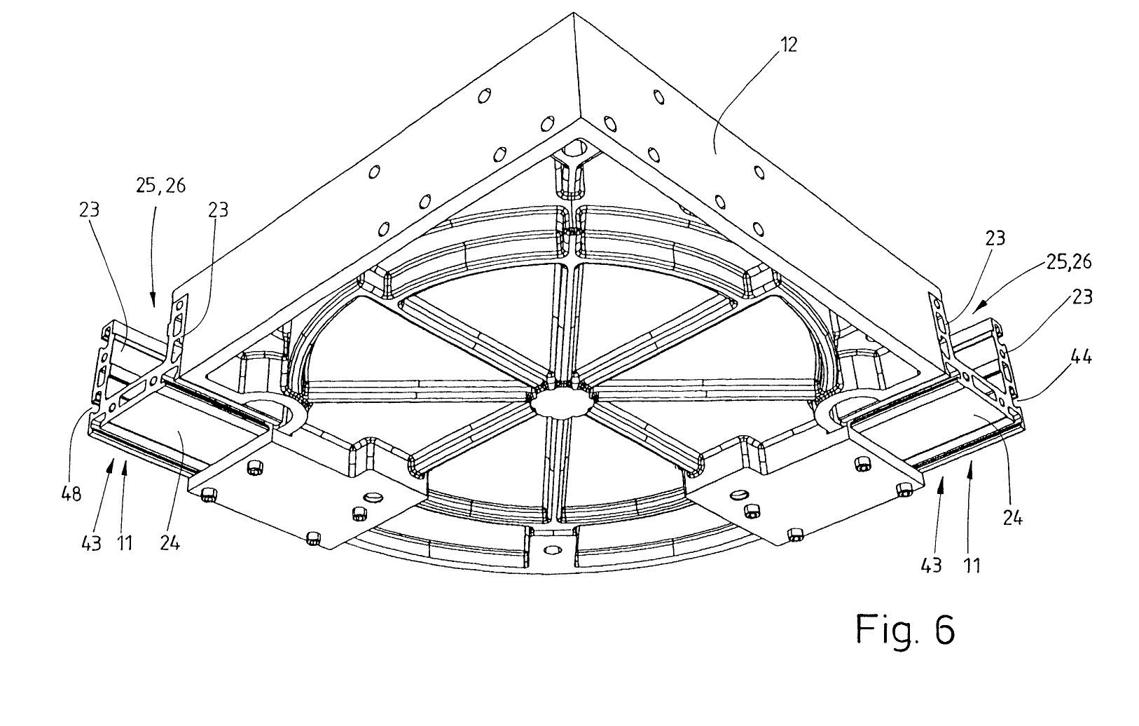

FIG. 6 the deflector of FIGS. 4 and 5 from below,

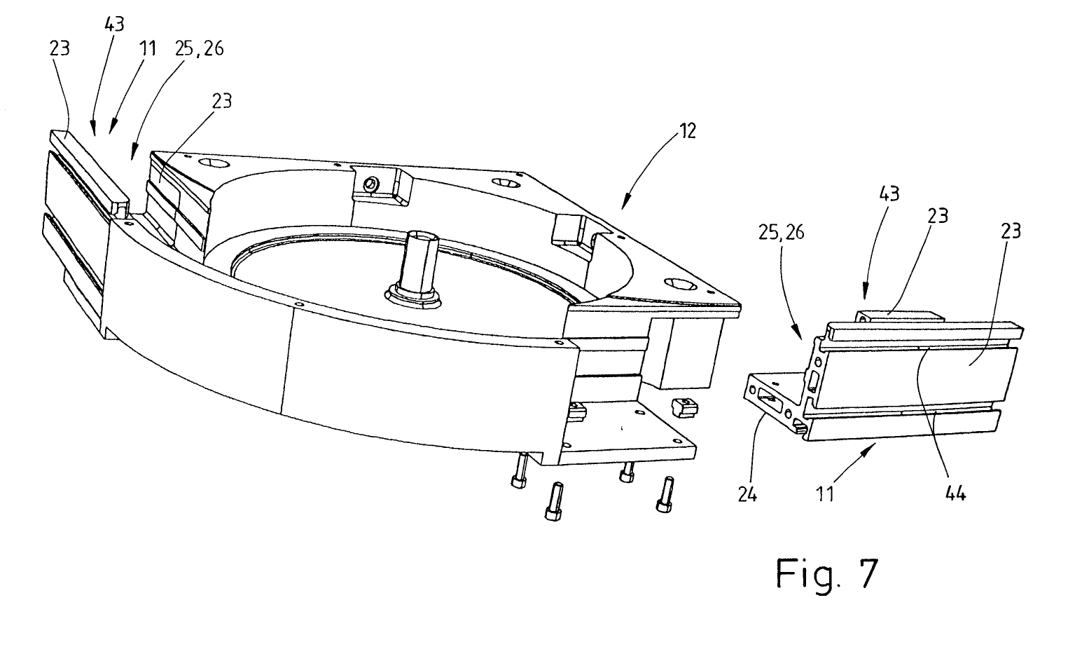

FIG. 7 the deflector of FIGS. 4 to 6 with an unmounted end of a profile section, and

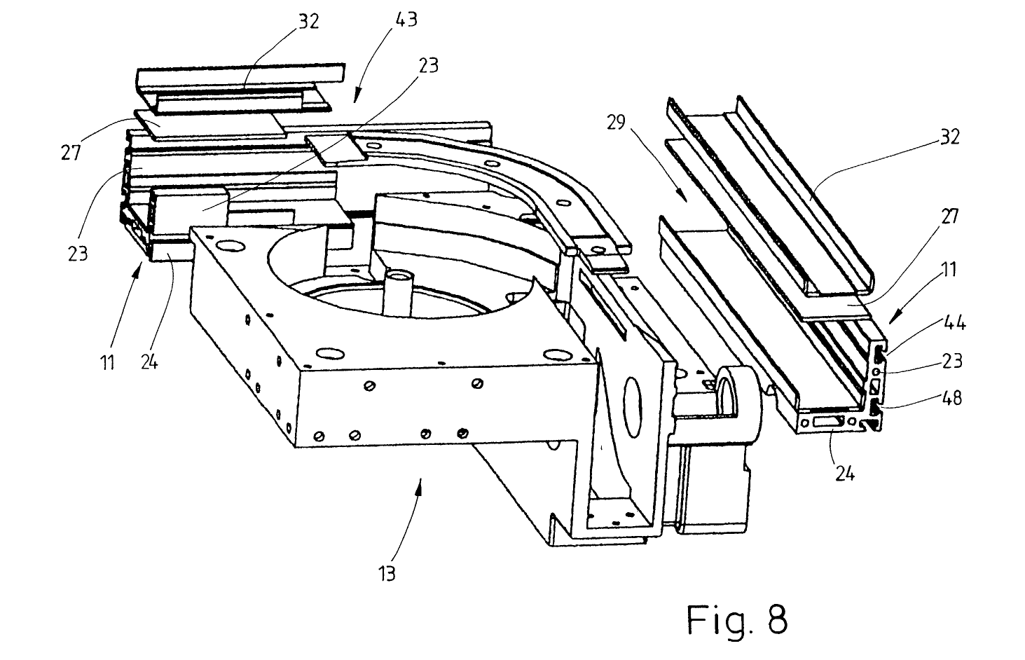

FIG. 8 a perspective view of a shunt between a plurality of profile sections.

The figures show one type of the conveyor according to the invention, which is configured as a accumulating roller conveyor 10. This kind of conveyor is employed for the continued transport of workpieces along a assembly line, for instance. The workpieces are preferably arranged on workpiece holders which rest on the accumulating roller conveyor 10 and which are transported by the latter along the assembly line.

The accumulating roller conveyor 10 features a conveying path, not shown in the figures, whose course is individually adjusted to the existing assembly line. The conveying path is formed preferably by a plurality of elongate profile sections 11 whose ends are connected to one another by deflectors 12 and/or shunts 13. In the region of the deflectors 12, the conveying path is led in a curve. The shunts 13 are used to branch the conveying path. In particular in the region of at least some deflectors 12, there is a drive for a conveying strand of the conveying path.

The conveyor strand of the accumulating roller conveyor 10 shown here is formed by a accumulating roller chain 14 which has an endless configuration and which is driven in continuous rotation along the conveying path. The endless accumulating roller chain 14 has an top belt 15 and a bottom belt 16. The top belt 15 is used for the further transport of the workpiece supports bearing the workpieces. For this purpose, the workpiece holders rest on the top belt 15. The bottom belt 16 is used to return the endless accumulating roller chain 14 to a start of the conveying path and is returned empty under top belt 15 in a return channel.

The accumulating roller chain 14 is formed from a plurality of chain parts 17 lying one behind the other. The individual, uniformly shaped chain parts 17 are connected to one another in an articulate fashion; in the shown exemplary embodiment by means of ball-and-socket joints 18. Each chain part 17 is associated with a elongate, cylindrical accumulating roller 19. The accumulating roller 19 projects with an upper and lower arcuate portion beyond an upper side 20 and a lower side 21 of the respective chain part 17. The accumulating roller 19 can be freely rotated about a horizontal rotational axis 22 running transverse to the longitudinal axis of the accumulating roller 14.

Taken from one of the uniformly constructed profile sections 11, FIGS. 1 to 3 show a portion of a profile section 11. The profile section 11 has a U-shaped cross-section open at the top. To this end, the profile section 11 formed as a one-piece extruding press profile of aluminum, for example, is made up of two parallel side walls 23 and a bottom wall 24 connecting them on the lower side. Located between the upper ends of the two parallel side walls 23 is a completely open top side 25. Thus formed between the side walls 23 is a receiving space 26 accessible from the open side 25. In the continuously open and singular receiving space 26 of the profile section 11, the top belt 15 and the bottom belt 16 of the accumulating roller chain 14 can be accommodated one above the other, with the bottom belt 16 running parallel underneath and at distance to the top belt 15. The receiving space 26 is sub-divided approximately in the middle by a flat dividing plate 27 extending along the profile section 11. The dividing plate 27 forms two sectional spaces 28 and 29 in the receiving space 26 of the profile section 11. The sectional space 29 located below the dividing plate 27 is completely closed. It is bordered by parts of the parallel side walls 23, the bottom wall 24 and the dividing plate 27. Located above the dividing plate 27 is the upper sectional space 28, which is bordered by the upper portions of the parallel side walls 23 and the dividing plate 27. The upper sectional space 28 is open on its upper side by virtue of the upper open side 25 of the profile section 11. The bottom belt 16 is accommodated in the lower sectional space 29, with the lower sectional space 29 forming the return channel for the bottom belt 16. The top belt 15 of the accumulating roller chain 14 is arranged in the upper sectional space 28 in such a manner that the top belt 15 of the workpiece holders or another object to be conveyed can lie on the top side 20.

According to the invention, the dividing plate 27 is detachably installed in the receiving space 26 of the profile section 11, specifically through the upper open side 25 of the profile section 11. The dividing plate 27 rests on a projection 31 at the inner side 30 of each side wall 23. The facing projections 31 of the opposing side walls 23 run continuously in the longitudinal direction of the profile section 11 and assume a uniform distance from the bottom wall 24. In this manner, the dividing plate 27 resting on the projections 31 runs parallel to the bottom wall 24.

By virtue of the releasable arrangement of the dividing plate 27 in the receiving space 26 of the profile section 11, the lower sectional space 29 can also be open when the dividing plate 27 is removed, i.e. accessible from the open side 25 on the upper side of the profile section 11. By this arrangement, the lower sectional space 29 in the profile section is also accessible from the top, open side 25 for the purpose of inserting the bottom belt 16 of the accumulating roller chain 14 into the receiving space 26 of the profile section 11 when the dividing plate 27 is removed from the profile section 11 (FIG. 1). After the bottom belt 16 is inserted in the receiving space 26 of the profile section 11, the dividing plate 27 is placed in the profile section 11, thus closing one side of the lower sectional space 29 in the profile section 11, on one hand, and on the other hand, creating at least an indirect bearing surface for the top belt 15 of the accumulating roller chain 14 which is subsequently to be laid in the profile section 11.

The accumulating roller chain 14 slides in the profile section 11 on guide profiles 32. A guide profile 32 is assigned to the bottom belt 16 as well as to the top belt 15. The guide profiles 32 for the top belt 15 and the bottom belt 16 have the same configuration. Each guide profile 32 has a bottom wall 33 and edge strips 34 associated to the opposing edges. The edge strips 34 are directed upwards perpendicular to the bottom wall 33 and have a height corresponding approximately to the height of the accumulating roller chain 14. The edge strips 34 are used for the lateral guidance of the opposing edges of the accumulating roller chain 14. The accumulating roller chain 14 rests on the bottom wall 33.

The opposite base surfaces 35, 36 of the bottom wall 33 of the guide profile 32 are configured differently. One base surface 35 runs straight along the entire cross-section of the guide profile 32. The base surface 36 on the other side, by contrast, is provided with a center recess 37. This recess 37 is somewhat wider than the length of the accumulating roller 19. The recess 37 is set back from the base surface 36 to such an extent that the portion of the accumulating rollers projecting beyond the accumulating roller chain 14 can enter the recess 37 without the outer surface of the accumulating rollers 19 being able to have rolling contact on the surface area 38 of the recess 37 set back from the base surface 36. Thus, the accumulating roller chain 14 slides along with one side (top side 20 or bottom side 21) of the chain parts 17 on opposite margins 39 adjacent to the recess 37 of the base surface 36 of the guide profile 32. The outer surfaces of the accumulating rollers 19 lie on the continuous, smooth base surface 35 such that the accumulating rollers 19 roll along the base surface 35. In the shown exemplary embodiment, the top belt 15 is assigned a guide profile 32 with a top-side base surface 36. Thus the accumulating rollers 19 extend into the recess 37 with their portions that project beyond the lower side 21 of the chain parts 17 so that the accumulating rollers come to a standstill when the top belt 15 of the accumulating roller chain 14 is moved along the (upper) guide profile 32. On the other hand, the bottom belt 16 is assigned a guide profile 32 with a top-side smooth base surface 35, and as the bottom belt 16 is moved further on the guide profile 32 the accumulating rollers 19 roll on the base surface 35 so that the bottom belt 16 can be moved along by rolling on the lower guide profile 32.

The edge strips 34 are connected in articulate fashion to the opposing edges of the bottom wall 33 of the guide profile 32. For this purpose, there are provided in the shown exemplary embodiment continuous film hinges 40 running between the edge strips 34 and the bottom wall 33 in the longitudinal direction of the guide profile 32. The film hinges 40 are formed during the manufacture of the single-piece guide profile 32 in that the guide profile 32 is made by thermoplastic extrusion. The thermoplastic synthetic used to form the guide profile 32 is one which exhibits good antifriction properties and low abrasion. The accumulating roller chain 14 can thus slide on the margins 39 of the bottom wall 33 of the corresponding guide profile 32 with a minimum of frictional resistance. In addition, the opposite edges of the accumulating roller chain 14 can thus slide along the edge strips 34 of the guide profile 32 with little frictional resistance.

The guide profiles 32 are held in the receiving space 26 of the profile section 11 by catch-locking. To this end, the upper edges 41 of the edge strips 34 of the guide profile 32 associated with the lower sectional space 29 are firmly locked under the projections 31 serving as the bearing surface for the dividing plate 27. The upper edges 41 of the edge strips 34 of the guide profile 32 associated with the upper sectional space 28 are catch-locked under separate catch noses 42 on the side walls 32 of the profile section 11. These catch noses 42 are located at a parallel distance above the projections 31 of the side walls 23. The catch noses 42 do no project as far out from the side wall 23 as the projections 31 so that the dividing plate 27 can clear the catch noses 42 when it is inserted through the open side 25 of the profile section 11 and put on top of the projections 31.

The profile section 11 shown here has in the bottom wall 24 as well as in each side wall 23 two uniformly configured grooves 44 arranged at a distance from one another. Each groove 44 is provided with a T-shaped cross-section. A transverse leg 45 of the T-shaped groove 44 lies in the interior of the respective side wall 23 or bottom wall 24 and runs parallel to the outer surface 46. A web 47 of the T-shaped groove 44 running transverse to the leg 45 connects the groove 44 to the respective outer surface 46. Created at the point where the web 47 of the respective groove 44 opens out at the outer surface 46 is a slit 48, open on the outside, which runs in the longitudinal direction of the profile section 11.

The web side walls 49 which delimit the web 47 on opposite sides between the outer surface 46 of the side walls 23 or of the bottom wall 24 and the respective leg 45 of the 25 groove 44 have a stepped configuration according to the invention. The steps are designed such that the web side walls 49 widen toward the inner side of the profile section 11, i.e. toward the respective leg 45 of the groove 44. Consequently, two parallel side wall parts 50 adjoin the respective outer side 46. These are followed by step strips 51 which run obliquely or, as the case may be, parallel to the side wall parts 50. The step strips 51 are adjoined in turn by two parallel side wall parts 52, whose distance to one another is greater than the distance between the outer side wall parts 50. The inner (and greater spaced) side wall parts 52 form the transition to the leg 45 of the groove 44.

By virtue of the step configuration of the web 47 of the respective groove 44 on one hand, and the larger leg 45 of the groove 44, on the other hand, it is possible to arrange various fastening means, in particular tenon blocks having heads of various widths, in the groove 44 in a displaceable but not rotatable manner.

FIGS. 4 to 8 show how ends of the profile sections 11 are connected with the deflector 12 or shunt 13 to form various sections of the conveying path. A profile section 11 of uniform cross-section is always used to form the individual portions of the conveying path. A profile section 11 is altered only in its length in order to fit the corresponding portion of the conveying path.

The ends 43 of the profile sections 11 for connecting to the shunt 13 (FIGS. 4 and 7) are uniformly configured. This is done by removing parts of the respective profile section 11 in the region of its ends 43. In the shown exemplary embodiment, a short portion of a side wall 23 of the profile section 11 has been removed in the region of the respective end 43. This applies equally to the end 43 of each profile section 11 connected to the shunt 13. This allows for a particularly easy connection of the profile section 11 to the shunt 13 without any specially designed profile fittings.

At the shunt 13 the profile section 11 leading into it is provided with an end 43 identical to the ends 43 of the other profile sections 11 connected to the deflector 12 (FIG. 8). A profile section 11 running continuously in the region of the shunt 13 is likewise provided with only one side wall 23 in the region of the shunt 13 by having the a side wall 23 removed from the profile section 11 in the area of the shunt 13.

1. Conveyor for workpieces with a profile section, which forms at least in part a conveyor path, and a continuously driven conveyor strand guided by said profile section, characterized in that the profile section (11) has on one side (25) an open receiving space (26) into which a bottom belt (16) and a top belt (15) of the conveyor strand can be inserted from the open side (25).

2. Conveyor according to claim 1, characterized in that the receiving space (26) in the profile section (11) is arranged and designed such that the bottom belt (10) and top belt (15) of the accumulating roller chain (14) arranged therein are each accessible from the open side of the profile section (11).

3. Conveyor according to claim 1, characterized in that the receiving space (26) can be divided into a plurality of sectional spaces (28, 29) by at least one dividing plate (27).

4. Conveyor according to claim 3, characterized in that the receiving space (26) can be divided into the sectional spaces (28, 29) by at least one dividing plate (27) detachably associated with the profile section (11).

5. Conveyor according to claim 3, characterized in that the sectional spaces (28, 29) lie one above the other.

6. Conveyor according to claim 3, characterized in that the sectional space (29) for receiving the bottom belt (16) of the conveyor strand is also accessible from the open side (25) of the receiving space (26) of the profile section (11).

7. Conveyor according to claim 6, characterized in that the sectional space (29) for the bottom belt (16) can be closed by the dividing plate (27).

8. Conveyor according to claim 3, characterized in that the dividing plate (27) forms a bottom wall of the upper sectional space (28) of the profile section (11) and a top side of the upper sectional space (28) opposite the dividing plate (27) is assigned to the open side (25) of the profile section (11).

9. Conveyor according to claim 3, characterized in that the dividing plate (27) separating the receiving space (26) in the profile section (11) into the two sectional spaces (28, 29) lies, preferably unattached, on opposing, upright side walls (23) of the profile section (11).

10. Conveyor according to claim 3, characterized in that a bottom wall (33) of at least one sectional space (28, 29) is assigned a sliding layer for at least the top belt (15) of the conveyor strand.

11. Conveyor according to claim 10, characterized in that the or each sliding layer is formed by a guide profile (32) in the corresponding sectional space (28, 29).

12. Conveyor according to claim 11, characterized in that each guide profile (32) has edge strips (34) assigned to a bottom wall (33) and opposing sides of same, with the edge strips (34) being assigned opposing side walls (23) of the receiving space (26) of the profile section (11).

13. Conveyor according to claim 12, characterized in that the edge strips (34) can be pivoted with respect to the bottom wall (33).

14. Conveyor according to claim 10, characterized in that the bottom wall (33) has on one side a continuous recess (37) running in the longitudinal direction of the guide profile (32).

15. Conveyor according to claim 11, characterized in that the guide profile (32) is made of a material which has a lower frictional value than the material of the profile section (11).

16. Conveyor for workpieces with a conveying path formed by at least one profile section and function elements and a continuously driven conveyor strand guided in the conveying path, characterized in that the profile section (11) is configured such that its ends (43) are capable of fitting connection points of the function elements.

17. Conveyor according to claim 16, characterized in that all ends (43) of the profile section (11) are configured to fit the function elements, including different function elements.

18. Conveyor according to claim 16, characterized in that the function elements are designed for the detachable connection to one another.

19. Conveyor according to claim 16, characterized in that grooves are assigned to at least one of two uniformly configured side walls (23) of the profile section (11).

20. Conveyor according to claim 19, characterized in that two parallel grooves are assigned to at least the side walls.

21. Conveyor according to claim 19, characterized in that the grooves (44) are configured to receive different fastening means.

22. Conveyor according to claim 19, characterized in that the grooves (44) are configured with a T-shaped cross-section with a leg (45) and a web (47) transverse thereto for the formation of a narrow slit (48) in the outer surfaces (46) of at least the side walls (23).

23. Conveyor according to claim 22, characterized in that the web (47) has various widths, with the greatest width of the web (47) pointing to the leg (45) of the groove (44).
